(19) United States
(12) Patent Application Publication
(10) Pub. No.: US 2011/0065032 A1
(43) Pub. Date: Mar. 17, 2011

(54) ELECTROPHOTOGRAPHIC POHOTORECEPTOR, IMAGE FORMING METHOD, IMAGE FORMING APPARATUS, AND PROCESS CARTRIDGE FOR IMAGE FORMING APPARATUS USING THE PHOTORECEPTOR

(75) Inventors: Kazukiyo NAGAI, Numazu-shi (JP); Li Hongguo, Numazu-shi (JP); Tetsuro Suzuki, Fuji-shi (JP)

(73) Assignee: RICOH COMPANY , LTD., Tokyo (JP)

(21) Appl. No.: 12/881,406

(22) Filed: Sep. 14, 2010

(30) Foreign Application Priority Data
Sep. 15, 2009 (JP) 2009-212696

(51) Int. Cl. G03G 13/04; G03G 5/047; G03G 21/18; G03G 15/00

(52) U.S. Cl. 430/48; 430/58.5; 399/111; 399/159

(57) ABSTRACT

An electrophotographic photoreceptor, including an electroconductive substrate; a charge generation layer overlying the substrate; a first charge transport layer mostly formed of a molecular dispersion film in which a binder resin comprises a low-molecular-weight charge transport material, overlying the charge generation layer; and a second charge transport layer formed of a crosslinked film obtained by irradiating a composition obtained by mixing a radical polymerizable charge transport compound, a tri- or more functional radical polymerizable monomer, and a photopolymerization initiator with ultraviolet radiation to conduct a radical curing reaction, overlying the first charge transport layer, wherein the crosslinked film comprises at least one of the specific 2,5-diaryl-1,3,4-oxadiazole derivatives.

### BACKGROUND OF THE INVENTION

1. Field of the Invention

The present invention relates to an image forming method and an image forming apparatus using an electrophotographic method capable of on-demand printing in commercial printing fields, and an electrophotographic photoreceptor and a process cartridge for the image forming apparatus used therein.

2. Discussion Of The Related Art

In recent years, since on-demand printing is easy, an electrophotographic image forming apparatus which has become widely used in the office has begun to spread to the commercial printing field as well. In the commercial printing field, high-speed printing, large-scale printing, high image quality, paper responsiveness, and reduction in the cost of printed materials are demanded more than ever before.

In order to attain high speed-printing, large-scale printing, and reduction in the cost of printed materials, it is necessary that an electrophotographic photoreceptor which is a central device of electrophotography be durable and have a long shelf life. As photoreceptors, both an inorganic photoreceptor, a representative of which is amorphous silicon, and an organic photoreceptor including an organic charge generating material and an organic charge transporting material, are used. However, organic photoreceptors are thought to be superior for several reasons, including (I) optical properties such as a width of a light absorbing wavelength region and a magnitude of an absorption amount, (II) high sensitivity, and electric properties such as safe electrostatic charging properties, (III) a wide selection range of materials, (IV) ease of manufacturing, (V) low cost, and (VI) non-toxicity, etc. On the other hand, organic photoreceptors are susceptible to scratches that can cause image defects and abrasions that can cause deterioration in sensitivity, deterioration in electrostatic charging properties, and charge leakage, all of which can cause abnormal images such as reduction in image density and background staining.

As a way to improve the scratch resistance and abrasion resistance of organic photoreceptors, a photoreceptor in which a mechanically tough protective layer is formed on the previous organic photoreceptor is proposed. For example, Patent Document 1 (JP-2000-66425-A) discloses a photosensitive layer containing a compound in which a hole transporting compound having two or more chain polymerizable functional groups in the same molecule is cured. Since this photosensitive layer can enhance a crosslinking bond density, it has high hardness, but since a bulky hole transporting compound has two or more chain polymerizable functional groups, strain in the cured material is generated, a curing reaction becomes uneven, a restoring force against external stress is locally reduced, and cracks and scratches are easily generated by stress such as carrier attachment upon repetitive use for a long period of time.

In addition, a photoreceptor having improved scratch resistance of a photoreceptor having a crosslinked surface layer chemically bound to a charge transport structure has been proposed. For example, Patent Documents 2, 3 and 4 (JP-2006-113321-A, JP-4145820-B, and JP-2004-302451-A) have proposed a photoreceptor having, as a protective layer, a crosslinked film obtained by irradiating a composition obtained by mixing a radical polymerizable charge transporting compound, a tri- or more functional radical polymerizable monomer, and a photopolymerization initiator with ultraviolet radiation to conduct a radical curing reaction. Since this photoreceptor has excellent scratch resistance and abrasion resistance as well as excellent environmental stability, it can output an image stably without using a drum heater.

In addition, Patent Document 5 (JP-2004-302452-A) has proposed that the charge transporting compound of a photoreceptor having, as a protective layer, a crosslinked film obtained by irradiating a composition obtained by mixing the radical polymerizable charge transporting compound, the tri- or more functional radical polymerizable monomer, and the photopolymerization initiator with ultraviolet radiation to conduct a radical curing reaction prevents deterioration of a photosensitive material during photoreceptor manufacturing by containing an ultraviolet ray absorbing agent in the crosslinked film, in order to prevent reduction in electric properties due to ultraviolet ray irradiation.

The photoreceptor has excellent scratch resistance and abrasion resistance, is better in electric property as a whole photoreceptor, and is suitable for commercial printing in which printing is performed on a large scale. However, more recent commercial printing requires high image quality more than ever before, and prevention of deterioration in photosensitive material alone cannot sufficiently respond to such demand.

Accordingly, there is market demand for development of a photoreceptor that can form an image of higher quality than ever before without a concomitant reduction in scratch resistance and abrasion resistance of a photoreceptor having, as a protective layer, a crosslinked film obtained by irradiating a composition obtained by mixing the radical polymerizable charge transporting compound, the tri- or more functional radical polymerizable monomer, and the photopolymerization initiator with ultraviolet radiation to conduct a radical curing reaction.

For these reasons, a need exists for a photoreceptor capable of producing higher-quality images without a concomitant reduction in scratch resistance and abrasion resistance.

### SUMMARY OF THE INVENTION

Accordingly, an object of the present invention is to provide a photoreceptor capable of producing higher quality images without reducing the scratch resistance and abrasion resistance.

Another object of the present invention is to provide an image forming method using the photoreceptor.

A further object of the present invention is to provide an image forming apparatus using the photoreceptor.

Another object of the present invention is to provide a process cartridge for image forming apparatus, using the photoreceptor.

To achieve such objects, the present invention contemplates the provision of an electrophotographic photoreceptor, comprising:

an electroconductive substrate;

a charge generation layer overlying the substrate;

a first charge transport layer mostly formed of a molecular dispersion film in which a binder resin comprises a low-molecular-weight charge transport material, overlying the charge generation layer; and

a second charge transport layer formed of a crosslinked film obtained by irradiating a composition obtained by mixing a radical polymerizable charge transport compound, a tri- or more functional radical polymerizable monomer and a photopolymerization initiator with ultraviolet radiation to conduct a radical curing reaction, overlying the first charge transport layer,

wherein the crosslinked film comprises at least one of 2,5-diaryl-1,3,4-oxadiazole derivatives having the following formulae (1) and (2):

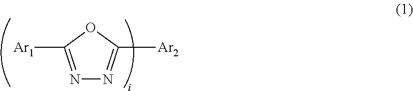

wherein i represents an integer of 1 to 4, Ar₁, when i=1, represents a naphthyl group or a biphenylyl group and, when i is 2 to 4, represents an aryl group, the plurality of aryl groups may be the same or different, and Ar₂, when i=1, represents a naphthyl group or a biphenylyl group, when i is 2 to 4, represents a divalent to tetravalent group of a benzene ring corresponding to I; and

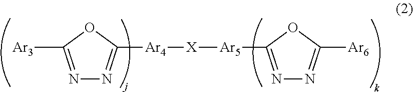

wherein j and k represent an integer of 1 to 2, Ar₃ and Ar₆ represent an aryl group, Ar₄ represents a divalent to tetravalent group of a benzene ring, Ar₅ represents a divalent group or trivalent group of a benzene ring corresponding to k, and X represents a divalent hydrocarbon group, and may be taken together with adjacent Ar₄ to form a ring structure via a substituent.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a sectional view illustrating an embodiment of the electrophotographic photoreceptor of the present invention;

FIG. 2 is a schematic view illustrating an embodiment of the image forming apparatus of the present invention;

FIG. 3 is a schematic view illustrating an embodiment of the process cartridge for the image forming apparatus of the present invention;

FIG. 4 is a schematic view illustrating a method of measuring elastic displacement with a microscopic surface hardness meter; and

FIG. 5 is a diagram showing a relation between plastic displacement and elastic displacement relative to a load.

### DESCRIPTION OF THE PREFERRED EMBODIMENTS

Generally, the present invention provides a photoreceptor capable of producing higher quality images without reducing the scratch resistance and abrasion resistance. More particularly, the present invention relates to an electrophotographic photoreceptor, comprising:

an electroconductive substrate;

a charge generation layer overlying the substrate;

a first charge transport layer mostly formed of a molecular dispersion film in which a binder resin comprises a low-molecular-weight charge transport material, overlying the charge generation layer; and

a second charge transport layer formed of a crosslinked film obtained by irradiating a composition obtained by mixing a radical polymerizable charge transport compound, a tri- or more functional radical polymerizable monomer and a photopolymerization initiator with ultraviolet radiation to conduct a radical curing reaction, overlying the first charge transport layer,

wherein the crosslinked film comprises at least one of 2,5-diaryl-1,3,4-oxadiazole derivatives having the following formulae (1) and (2):

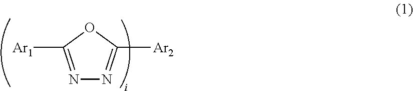

wherein i represents an integer of 1 to 4, Ar₁, when i=1, represents a naphthyl group or a biphenylyl group and, when i is 2 to 4, represents an aryl group, the plurality of aryl groups may be the same or different, and Ar₂, when i=1, represents a naphthyl group or a biphenylyl group, when i is 2 to 4, represents a divalent to tetravalent group of a benzene ring corresponding to I; and

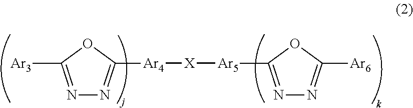

wherein j and k represent an integer of 1 to 2, Ar₃ and Ar₆ represent an aryl group, Ar₄ represents a divalent to tetravalent group of a benzene ring, Ar₅ represents a divalent group or trivalent group of a benzene ring corresponding to k, and X represents a divalent hydrocarbon group, and may be taken together with adjacent Ar₄ to form a ring structure via a substituent.

The present invention prevents occurrence of variation in a light attenuation potential at in-plane respective places of a photoreceptor having a crosslinked film obtained by irradiating a composition obtained by mixing a radical polymerizable charge transport compound, a tri- or more functional radical polymerizable monomer and a photopolymerization initiator with ultraviolet radiation to conduct a radical curing reaction and, improves in-plane uniformity of an electrophotographic photoreceptor and makes it possible to form an image of high quality required in commercial printing by adding a specified 2,5-diaryl-1,3,4-oxadiazole derivative during formation of the crosslinked film.

A photoreceptor capable of forming an image of high quality required in commercial printing is required to have such in-plane potential uniformity that, when the same light writing is performed, a potential becomes the same potential at any place, and it is required to suppress variation of the film thickness and homogeneity of a second charge transport layer (crosslinked surface layer).

Even when elusion of constituent materials etc. of a lower layer onto a crosslinked surface layer is prevented and a uniform coated film is formed, because of light reflection at a lamp boundary region of an ultraviolet ray irradiating apparatus or in the apparatus during crosslinking and curing, variation in ultraviolet ray irradiation to a photoreceptor surface occurs, and it gives influence on the film thickness and homogeneity of a crosslinked layer. It is predicted that variation in light irradiation leads to variation in the crosslinking density of a crosslinked protective layer, and avoidance of variation in the crosslinking density was tried by increasing a light irradiation level, and allowing a whole to approach complete crosslinking, but there was no clear effect, and it was presumed that variation in light irradiation leads to variation in the degradation product generation amount of a radical polymerizable charge transport compound.

Then, an additive which prevents this light degradation and does not inhibit ultraviolet curing has been intensively studied, and it has been found out that addition of a 2,5-diaryl-1,3,4-oxadiazole derivative is effective. Details of the mechanism are unknown, but it is presumed that light degradation of a radical polymerizable charge transport compound can be inhibited by forming an intermolecular exciplex from a radical polymerizable charge transport compound which has absorbed light and formed into the singlet excited state and a specified 2,5-diaryl-1,3,4-oxadiazole derivative, and inactivating the charge transport compound.

However, when there is only one oxadiazole ring in a molecule, it is necessary that conjugation between adjacent aromatic groups is great to some extent, and only one benzene ring forms an exciplex with difficulty. By increasing conjugation to an extent of a naphthyl group or a biphenylyl group, it becomes possible to form an exciplex, and this exhibits good properties. In the case of a compound having two or more oxadiazole rings in the molecule, even when bound with a non-conjugated linking group X, there is no restriction like this. A reduction potential when an aromatic ring in which an oxadiazole ring in a molecule is present and adjacent, isolated from a non-conjugated linking group is one benzene ring is little different from that of a compound in which an oxadiazole ring is one in a molecule, but it is predicted that the presence of a plurality of oxadiazole groups having high electron receiving properties in the vicinity thereof advantageously exerts in an inactivation process of a charge transport compound.

Furthermore, it is presumed that light degradation of a radical polymerizable charge transport compound during ultraviolet ray irradiation can be inhibited without deteriorating fundamental electric properties and mechanical properties as a photoreceptor, due to a material group satisfying all conditions that an oxidation potential of a 2,5-diaryl-1,3,4-oxadiazole derivative is greater as compared with an oxidation potential of a radical polymerizable charge transport compound, therefore, the derivative even in a second charge transport layer does not become a hole trap, and does not reduce the charge transport ability and, further, the 2,5-diaryl-1,3,4-oxadiazole derivative has a short absorption wavelength in many cases, and has little absorption at a necessary wavelength region for ultraviolet ray curing, and does not inhibit a crosslinking reaction and, further, a level of the 2,5-diaryl-1,3,4-oxadiazole derivative is low as compared with an excitation orbital potential level of a radical polymerizable charge transport compound, and the derivative easily forms an exciplex.

It is conceivable that due to decrease in a degradation product in a second charge transport layer, if there is in-plane variation of ultraviolet ray irradiation, influence thereof is reduced, and potential stability in a photoreceptor plane is improved.

By using the electrophotographic photoreceptor, output of an image of high quality excellent in image concentration uniformity becomes possible.

The present invention will be described below in accordance with its layer structure.

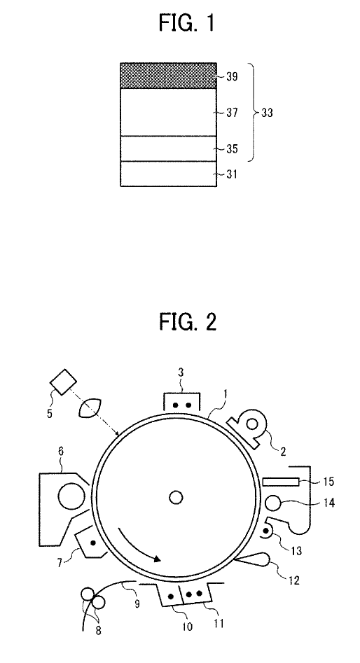

FIG. 1 is a cross-sectional view showing the electrophotographic photoreceptor of the present invention, and the photoreceptor is a photoreceptor having a laminated structure in which a charge generation layer (35) having the charge generation function, a first charge transport layer (37) having the electron transporting function and, further, a second charge transport layer (39) having the charge transport function are laminated on an electrically conductive support (31). These four layers are essential constitution and, furthermore, one layer or a plurality of layers of undercoat layers may be inserted between the electrically conductive support (31) and the charge generation layer (35). In addition, a layer constituting part including the charge generation layer (35), the first charge transport layer (37) and the second charge transport layer (39) is referred to as a photosensitive layer (33).

### <Electrically Conductive Support>

As the electrically conductive support (31), a previously known electrically conductive support is used.

The support may be aluminum, nickel etc. exhibiting electrical conductivity of a volume resistance of 10¹⁰ Ω·cm or less, and an aluminum drum, an aluminum-deposited film, a nickel belt etc. are preferably used.

For high image quality in the commercial printing field, since the dimensional precision of a photoreceptor is strictly required, a support obtained by subjecting an aluminum drum manufactured by a drawing method to cutting and polishing processing to improve the smoothness of a surface and dimensional precision is preferable. In addition, as the nickel belt, an endless nickel belt disclosed in JP-A No. 52-36016 gazette can be used.

### <Charge Generation Layer>

As the charge generation layer (35), a charge generation layer which has been used in the previous organic electrophotographic photoreceptor can be used as it is. That is, it is a layer containing a charge generation material having the charge generation function as a main component and, if necessary, a binder resin can be used together. Preferable charge generation materials are, for example, phthalocyanine-based pigments such as metal phthalocyanine and metal-free phthalocyanine, and azo pigments and, as the metal phthalocyanine, titanyl phthalocyanine, chlorogallium phthalocyanine, hydroxygallium phthalocyanine etc. are used. These charge generation materials can be used alone, or as a mixture of two or more kinds of them.

Examples of the binder resin which is used as necessary include polyamide, polyurethane, an epoxy resin, polyketone, polycarbonate, a silicone resin, an acrylic resin, polyvinyl butyral, polyvinyl formal, polyvinyl ketone, polystyrene, poly-N-vinylcarbazole, and polyacrylamide. These binder resins can be used alone, or as a mixture of two or more kinds of them.

The charge generation layer (35) can be formed, for example, by dispersing the charge generation material with a ball mill, an attritor, a sand mill, a bead mill etc. using, if necessary, the binder resin together with a solvent such as tetrahydrofuran, dioxane, dioxolane, toluene, dichloromethane, monochlorobenzene, dichloroethane, cyclohexanone, cyclopentanone, anisole, xylene, methyl ethyl ketone, acetone, ethyl acetate, butyl acetate etc., and appropriately diluting and coating the dispersion. In addition, if necessary, a leveling agent such as a dimethyl silicone oil or a methyl phenyl silicone oil can be added. Coating can be performed using an immersion coating method, or a spray coating, bead coating, or ring coating method. The film thickness of the charge generation layer provided as described above is suitably around 0.01 to 5 μm, preferably 0.05 to 2 μm.

### <First Charge Transport Layer>

As the first charge transport layer, a previously known charge transport layer in which a charge transport substance is dispersed in a binder resin can be used as it is.

As the charge transport substance, a hole transporting substance is preferable, and a previously known material can be used as it is. Examples thereof include an oxazole derivative, an imidazole derivative, a monoarylamine derivative, a diarylamine derivative, a triarylamine derivative, a stilbene derivative, an α-phenylstilbene derivative, a benzidine derivative, a diarylmethane derivative, a triarylmethane derivative, a 9-styrylanthracene derivative, a pyrazoline derivative, a divinylbenzene derivative, a hydrazone derivative, an indene derivative, a butadiene derivative, a pyrene derivative, a bisstilbene derivative and an enamine derivative. These substances can be used alone, or by mixing them.

Examples of the binder resin include thermoplastic or thermosetting resins such as polystyrene, a styrene-acrylonitrile copolymer, a styrene-butadiene copolymer, a styrene-maleic anhydride copolymer, polyester, polyvinyl chloride, a vinyl chloride-vinyl acetate copolymer, polyvinyl acetate, polyvinylidene chloride, a polyacrylate resin, a phenoxy resin, polycarbonate, a cellulose acetate resin, an ethylcellulose resin, polyvinyl butyral, polyvinyl formal, polyvinyltoluene, poly-N-vinylcarbazole, an acrylic resin, a silicone resin, an epoxy resin, a melamine resin, a urethane resin, a phenol resin and an arkyd resin. It is suitable that the amount of the charge transport substance is 20 to 300 parts by weight, preferably 40 to 150 parts by weight relative to 100 parts by weight of the binder resin. As a solvent used in coating of the first charge transport layer, the same solvent for the charge generation layer can be used, and a solvent which dissolves the charge transport substance and the binder resin well is suitable. These solvents may be used alone, or by mixing two or more kinds of them. In addition, for formation, the same coating method as that for the charge generation layer (35) is possible.

In addition, if necessary, a plasticizer and a leveling agent may be added. As the plasticizer which can be used together in the charge transport layer, a plasticizer which is used as a plasticizer of general resins such as dibutyl phthalate and dioctyl phthalate can be used as it is and the amount thereof used is suitably around 0 to 30 parts by weight relative to 100 parts by weight of the binder resin. As the leveling agent which can be used together in the charge transport layer, silicone oils such as a dimethylsilicone oil and a methylphenylsilicone oil, and polymers or oligomers having a perfluoroarkyl group on a side chain are used, and it is suitable that the amount thereof used is around 0 to 1 part by weight relative to 100 parts by weight of the binder resin. It is suitable that the film thickness of the first charge transport layer is suitably around 5 to 40 μm, preferably around 10 to 30 μm. A second charge transport layer is formed on the thus formed first charge transport layer.

### <Second Charge Transport Layer>

The present invention is has a feature that the second charge transport layer is formed of a crosslinked film obtained by irradiating a composition obtained by mixing at least a radical polymerizable charge transport compound, a tri- or more functional radical polymerizable monomer, and a photopolymerization initiator with an ultraviolet ray to conduct a radical curing reaction, and that a 2,5-diaryl-1,3,4-oxadiazole derivative is contained in the crosslinked film.

The specified 2,5-diaryl-1,3,4-oxadiazole derivative which is a material essential to the present invention is represented by the following general formula (1) or general formula (2):

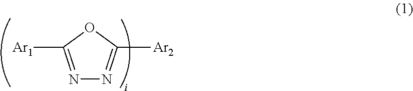

wherein i represents an integer of 1 to 4, Ar₁, when i=1, represents a naphthyl group or a biphenylyl group and, when i is 2 to 4, represents an aryl group, the plurality of aryl groups may be the same or different, and Ar₂, when i=1, represents a naphthyl group or a biphenylyl group, when i is 2 to 4, represents a divalent to tetravalent group of a benzene ring corresponding to I; and

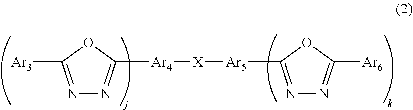

wherein j and k represent an integer of 1 to 2, Ar₃ and Ar₆ represent an aryl group, Ar₄ represents a divalent to tetravalent group of a benzene ring, Ar₅ represents a divalent group or trivalent group of a benzene ring corresponding to k, and X represents a divalent hydrocarbon group, and may be taken together with adjacent Ar₄ to form a ring structure via a substituent.

Ar₁ to Ar₆ in the present invention are not particularly limited, and may or may not have a substituent. In order to adjust physical properties such as solubility, a non-basic substituent such as an alkyl group having a carbon number of 1 to 3, an alkoxy group having a carbon number of 1 to 3, a chlorine atom, a diphenylamino group or a halogen atom may be introduced into Ar₁ Ar₃ Ar₆. When a substituent such as an amino group, an alkyl amino group or a dialkylamino group which is strong in basicity is possessed, a hole is trapped, an increase in a residual potential is caused, and the fundamental properties of an electrophotographic photoreceptor are deteriorated.

In addition, it is advantageous that oxadiazole has a reduction potential which is small to some extent, for forming an exciplex and, for this reason, the greater number of oxadiazole rings is advantageous. Oxadiazole in which Ar₁ Ar₃ Ar₆ is a phenyl group, a naphthyl group, or a biphenylyl group can be used and, in the case of i=1 in the general formula (1) where an oxadiazole ring is one, since a phenyl group as Ar₁ and Ar₂ makes a reduction potential insufficient, a naphthyl group or a biphenylyl group is preferable.

In addition, it is desirable that light adsorption of these 2,5-diaryl-1,3,4-oxadiazole derivatives inhibits a curing reaction during ultraviolet irradiation as little as possible and, for this reason, it is more preferably to select a derivative having an absorption end on a long wavelength side of 380 nm or less.

As a material group satisfying all of the above conditions, the following structures can be applied in the general formula (1) and the general formula (2).

Specific examples are described hereinbelow, but it is not limited thereto.

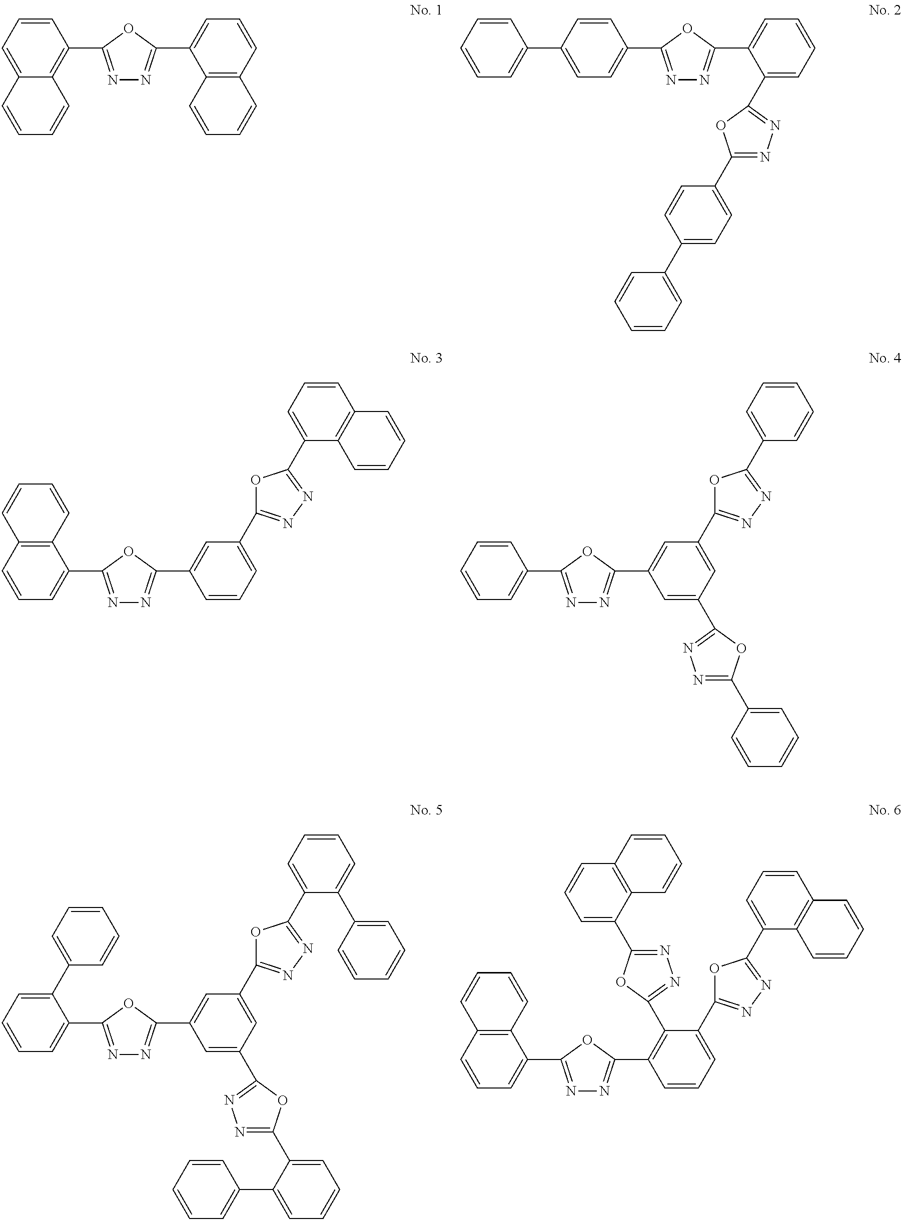

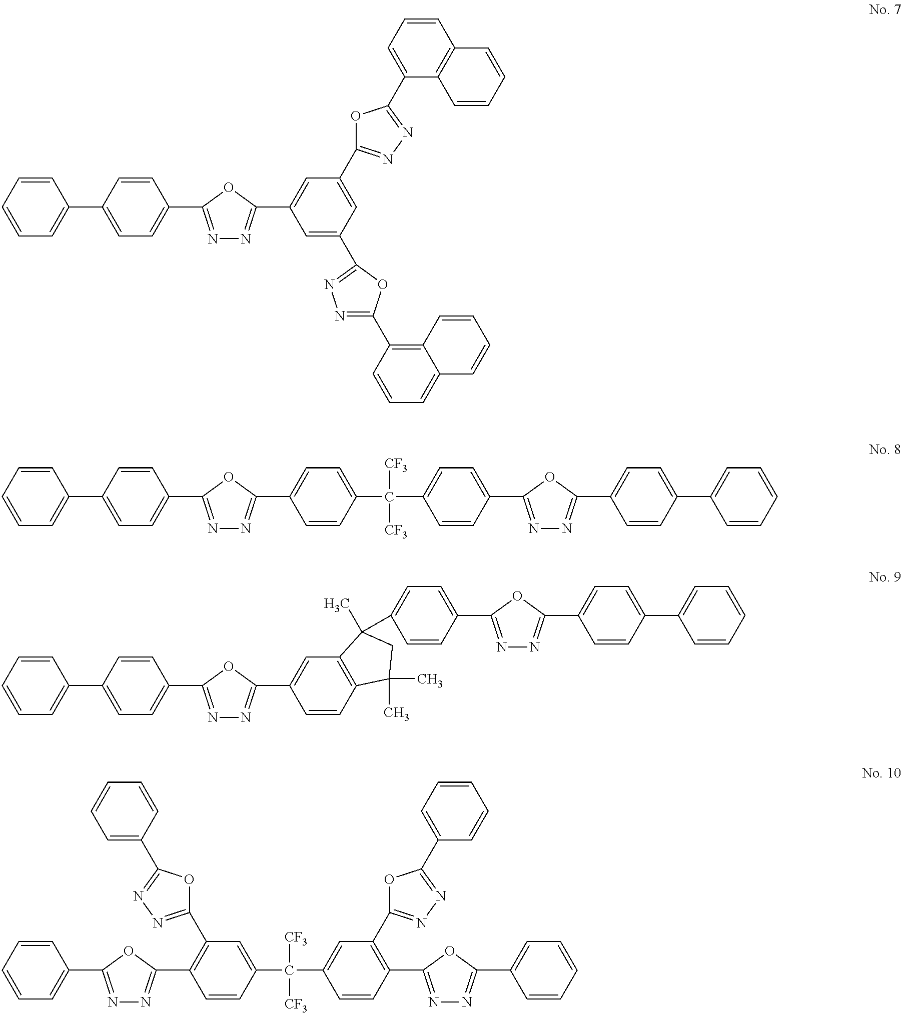

These 2,5-diaryl-1,3,4-oxadiazole derivatives are added to the second charge transport layer at a ratio of 0.1 to 10% by weight. When the rate is too small, the effect of reducing an in-plane potential variation amount becomes not to be seen and, when the ratio is too great, sensitivity properties of the photoreceptor are deteriorated.

Herein, with respect to the radical polymerizable charge transport compound, the tri- or more functional radical polymerizable monomer, the photopolymerization initiator, the coating solvent, the coating method, the drying method, the ultraviolet irradiation condition etc., previously known materials and methods can be applied. For example, the charge transport compounds having a radical polymerizable functional group, the tri- or more functional radical polymerizable monomers having no charge transport structure, and the photopolymerization initiators described in JP-A No. 2005-266513 gazette, JP-A No. 2004-302452 gazette, and U.S. Pat. No. 4,145,820 gazette can be used corresponding to the radical polymerizable charge transport compound, the tri- or functional radical polymerizable monomer, and the photopolymerization initiator of the present invention, and the coating solvent, the coating method, the drying method, and the ultraviolet ray irradiation condition described in these prior applications can be applied.

That is, the charge transport compound having a radical polymerizable functional group used in the present invention refers to a compound having a hole transport structure such as triarylamine, hydrazone, pyrazoline, and carbazole, for example, an electron transport structure such as an electron withdrawing aromatic ring having fused polycyclic quinone, diphenoquinone, a cyano group or a nitro group, and having a radical polymerizable functional group. As this radical polymerizable functional group, particularly, an acryloyloxy group and a mathacryloyloxy group are useful. The number of radical polymerizable functional groups in one molecule may be at least one, but in order to suppress internal stress of a crosslinked surface layer to easily obtain smooth surface properties, and in order to maintain good electric properties, it is preferable that the radical polymerizable functional group is one. When the charge transport compound has two or more radical polymerizable functional groups, the room degree thereof may be reduced from great strain due to fixation of a bulky hole transporting compound in a crosslinking bond with a plurality of bonds, and irregularity, cracking or film peeling may occur from a charge transport structure and the number of functional groups. In addition, an intermediate structure (cation radical) during charge transportation cannot be retained stably due to this great strain, a reduction in sensitivity and an increase in a residual potential due to trapping of a charge become easy to occur. As a charge transport structure of the charge transport compound having a radical polymerizable functional group, a triarylamine structure is preferable from high mobility.

The charge transport compound having a radical polymerizable functional group used in the present invention is important for imparting the charge transport performance to a crosslinked surface layer, and the content of a coating solution component is adjusted so that this component is 20 to 80% weight, preferably 30 to 70% by weight relative to the total crosslinked surface layer amount. When this component is less than 20% by weight, the charge transport performance of a crosslinked surface layer cannot be sufficiently retained, and deterioration of electric properties such as reduction in sensitivity and an increase in a residual potential appears by repetitive use. In addition, when the amount exceeds 80% by weight, the content of a trifunctional monomer having no charge transport structure is reduced, this easily leads to reduction in a crosslinking bond density, and high abrasion resistance is not exerted. Since required electric properties and abrasion resistance are different depending on a process used, it cannot be said unconditionally, but in view of balance between both properties, the range of 30 to 70% by weight is most preferable.

The tri- or more functional radical polymerizable monomer having no charge transport property used in the present invention refers to a monomer having no hole transport structure such as triarylamine, hydrazone, pyrazoline, and carbazole, for example, no electron transport structure such as an electron withdrawing aromatic ring having fused polycyclic quinone, diphenoquinone, a cyano group or a nitro group, and having three or more radical polymerizable functional groups. This radical polymerizable functional group may be any group which has a carbon-carbon double bond, and is radical-polymerizable. Examples thereof include trimethylolpropane triacrylate (TMPTA), trimethylolpropane trimethacrylate, trimethylolpropanealkylene-modified triacrylate, trimethylolpropaneethyleneoxy-modified (hereafter EO-modified) triacrylate, trimethylolpropanepropyleneoxy-modified (hereafter PO-modified) triacrylate, trimethylolpropanecaprolactone-modified triacrylate, trimethylolpropanealkylene-modified trimethacrylate, pentaerythritol triacrylate, pentaerythritol tetracrylate (PETTA), glycerol triacrylate, glycerol epichlorohydrin-modified (hereafter ECH-modified) triacrylate, glycerol EO-modified triacrylate, glycerol PO-modified triacrylate, tris(acryloxyethyl) isocyanurate, dipentaerythritol hexaacrylate (DPHA), dipentaerythritolcaprolactone-modified hexaacrylate, dipentaerythritolhydroxy pentaacrylate, alkylated dipentaerythritol pentacrylate, alkylated dipentaerythritol tetraacrylate, alkylated dipentaerythritol triacrylate, dimethylolpropane tetraacrylate (DTMPTA), pentaerythritolethoxy tetraacrylate, phosphoric acid EO-modified triacrylate, and 2,2,5,5-tetrahydroxymethylcyclopentanone tetracrylate. These may be used alone, or two or more kinds of them may be used together without any problem.

As the tri- or more functional radical polymerizable monomer having no charge transport structure, the ratio of a molecular weight relative to the functional group number in the monomer (molecular weight/functional group number) is desirably 250 or less, in order to form a dense crosslinking bond in a crosslinked surface layer. In addition, when this ratio is greater than 250, since the crosslinked surface layer is soft, and abrasion resistance is reduced to some extent, it is not preferable to use a monomer having an extreme long modified group alone, in a monomer having a modified group such as EO, PO or caprolactone. In addition, a content in a coating solution solid matter is adjusted, so that the component ratio of the tri- or more functional radical polymerizable monomer having no charge transport structure used in a surface layer becomes 20 to 80% by weight, preferably 30 to 70% by weight relative to the total amount of the crosslinked surface layer. When the monomer component is less than 20% by weight, the three-dimensional crosslinking bond density of the crosslinked surface layer is small, and dramatic improvement in abrasion resistance is not attained as compared with a previous case using a thermoplastic binder resin. Further, when the monomer component exceeds 80% by weight, the content of the charge transport compound is reduced, and deterioration in the electric properties is generated. Since required abrasion resistance and electric properties are different depending on a process used, it cannot be said unconditionally, but in view of balance between both properties, the range of 30 to 70% by weight is most preferable.

The photopolymerization initiator used in the present invention is not particularly limited as far as it is a polymerization initiator which easily generates a radical by light, and examples thereof include acetophenone-based or ketal-based photopolymerization initiators such as diethoxyacetophenone, 2,2-dimethoxy-1,2-diphenylethane-1-one, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1,2-hydroxy-2-methyl-1-phenylpropane-1-one, 2-methyl-2-morpholino(4-methylthiophenyl)propane-1-one, and 1-phenyl-1,2-propanedione-2-(o-ethoxycarbonyl)oxime, benzoin ether-based photopolymerization initiators such as benzoin, benzoin methyl ether, benzoin ethyl ether, benzoin isobutyl ether, and benzoin isopropyl ether, benzophenone-based photopolymerization initiators such as benzophenone, 4-hydroxybenzophenone, methyl o-benzoylbenzoate, 2-benzoylnaphthalene, 4-benzoylbiphenyl, 4-benzoyl phenyl ether, acrylated benzophenone, and 1,4-benzoylbenzene, thioxanthone-based photopolymerization initiators such as 2-isopropylthioxanthone, 2-chlorothioxanthone, 2,4-dimethylthioxanthone, 2,4-diethylthioxanthone, and 2,4-dichlorothioxanthone and, additional other photopolymerization initiators such as ethylanthraquinone, 2,4,6-trimethylbenzoyldiphenylphosphine oxide, 2,4,6-trimethylbenzoylphenylethoxyphosphine oxide, bis(2,4,6-trimethylbenzoyl)phenylphosphine oxide, bis(2,4-dimethoxybenzoyl)-2,4,4-trimethylpentylphosphine oxide, methyl phenyl glyoxy ester, 9,10-phenanthrene, acridine-based compound, triazine-based compound, and imidazole-based compound. These polymerization initiators may be used alone, or by mixing two or more kinds of them. The content thereof is 0.5 to 40 parts by weight, preferably 0.5 to 10 parts by weight relative to 100 parts by weight of the total inclusion material having radical polymerizability in a coating solution solid matter.

In the crosslinked surface layer of the present invention, monofunctional and difunctional radical polymerizable monomers and a radical polymerizable oligomer can be used together for the purpose of imparting the functions such as viscosity adjustment during coating, stress relaxation of the crosslinked surface layer, lower surface energy and a decrease in a friction coefficient. As these radical polymerizable monomers and the oligomer, known ones can be utilized.

The crosslinked surface layer of the present invention can be formed by coating a coating solution containing at least a tri- or more functional radical polymerizable monomer having no charge transport structure, a charge transport compound having a radical polymerizable functional group, a 2,5-diaryl-1,3,4-oxadiazole derivative represented by the general formula (1) and/or the general formula (2) and a photopolymerization initiator, followed by light curing. The coating solution, when the radical polymerizable monomer is a liquid, can also be coated by dissolving other components in this solution, but if necessary, is coated by diluting with a solvent. Examples of the solvent used thereupon include alcohol series such as methanol, ethanol, propanol, and butanol, ketone series such as acetone, methyl ethyl ketone, methyl isobutyl ketone, and cychlohexanone, ester series such as ethyl acetate, and butyl acetate, ether series such as tetrahydrofuran, dioxane, and propyl ether, halogen series such as dichloromethane, dichloroethane, trichloroethane, and chlorobenzene, aromatic series such as benzene, toluene, and xylene, and cellosolve series such as methyl cellosolve, ethyl cellsolve, and cellsolve acetate. These solvents may be used alone, or by mixing two or more kinds of them. The rate of dilution with a solvent is different depending on solubility of a composition, a coating method, and an objective film thickness, and is optional. Coating can be performed using an immersion coating method, a spray coating, bead coating, ring coating method.

In the present invention, a curing reaction proceeds by irradiation of light energy after coating the coating solution, thereby, the crosslinked surface is formed. As the light energy used thereupon, a UV irradiation light source such as a high pressure mercury lamp or a metal halide lamp having a light emission wavelength mainly in ultraviolet light can be utilized. An irradiation light level is preferably 50 mW/cm² or more and 1000 mW/cm² or less and, when the level is less than 50 mW/cm², the curing reaction takes a time. When the level is more intense than 1000 mW/cm², the progress of the reaction becomes ununiform, and irregularities are formed on the crosslinked surface layer and electric properties are deteriorated.

### <Undercoat Layer>

In the photoreceptor of the present invention, an undercoat layer can be provided between then electrically conductive support (31) and the photosensitive layer (33). The undercoat layer generally contains resins as a main component, and it is desirable that these resins, when it is conceivable that a photosensitive layer is coated thereon with a solvent, have high solvent resistance against general organic solvents. Examples of the resin include curable resins forming a three-dimensional network structure such as water-soluble resins including polyvinyl alcohol, casein and sodium polyacrylate, alcohol-soluble resins including copolymerized nylon and methoxymethylated nylon, polyurethane, a melamine resin, a phenol resin, an alkyd-melamine resin and an epoxy resin. In addition, fine powdery pigments of metal oxides such as titanium oxide, silica, alumina, zirconium oxide, tin oxide and indium oxide may be added to the undercoat layer for preventing moire, decreasing a residual potential etc. The undercoat layer can be formed using a suitable solvent and coating method as in the aforementioned photosensitive layer. Furthermore, in the undercoat layer of the present invention, a silane coupling agent, a titanium coupling agent, a chromium coupling agent etc. can also be used. In addition, as the undercoat layer of the present invention, an undercoat layer in which Al₂O₃ is provided by anode oxidation, and an undercoat layer in which an organic substance such as polyparaxylylene (parylene) or an inorganic substance such as SiO₂, SnO₂, TiO₂, ITO or CeO₂ is provided by a vacuum filmmaking method can also be suitably used. In addition, known ones can be used. The film thickness of the undercoat layer is suitably 1 to 15 μm.

### <Regarding Addition of Antioxidant to Each Layer>

In the present invention, an antioxidant can be added to each layer of the first charge transport layer, the second charge transport layer, the charge generation layer, the undercoat layer etc. for the purpose of improving environment resistance, inter alia, preventing reduction in sensitivity, and an increase in a residual potential. As the antioxidant to be added, previously known materials can be used, and examples thereof include the following.

(Phenol-Based Compound)

2,6-di-t-butyl-t-cresol, butylated hydroxylanisole, 2,6-di-t-butyl-4-ethylphenol, stearyl-β-(3,5-di-t-butyl-4-hydroxyphenyl) propionate, 2,2′-methylenebis-(4-methyl-6-t-butylphenol),2,2′-methylenebis-(4-ethyl-6-t-butylphenol), 4,4′-thiobis-(3-methyl-6-t-butylphenol), 4,4′-butylidenebis-(3-methyl-6-t-butylphenol), 1,1,3-tris(2-methyl-4-hydroxy-5-t-butylphenyl)butane, 1,3,5-trimethyl-2,4,6-tris(3,5-di-t-buthyl-4-hydroxybenzyl)benzene, tetrakis-[methylene-3-(3′,5′-di-t-butyl-4′-hydroxyphenyl)pr opionate]methane, bis[3,3′-bis(4′-hydroxy-3′-t-butylphenyl)butyric acid]glycol ester, tocopherols, etc.

(Paraphenylenediamines)

N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, N,N′-dimethyl-N,N′-di-t-butyl-p-phenylenediamine, etc.

(Hydroquinones)

2,5-di-t-octylhydroquinone, 2,6-didodecylhydroquinone, 2-dodecylhydroquinone, 2-dodecyl-5-chlorohydroquinone, 2-t-octyl-5-methylhydroquinone, 2-(2-octadecenyl)-5-methylhydroquinone, etc.

(Organic Sulfur Compounds)

dilauryl-3,3′-thiodipropionate, distearyl-3,3′-thiodipropionate, ditetradecyl-3,3′-thiodipropionate, etc.

(Organic Phosphorus Compounds)

triphenylphosphine, tri(nonylphenyl)phosphine, tri(dinonylphenyl)phosphine, tricresylphosphine, tri(2,4-dibutylphenoxy) phosphine, etc.

These compounds are known as antioxidants for rubbers, plastics, and oils and fats, and are easily commercially available.

The amount of the antioxidant added in the present invention is 0.01 to 10% by weight relative to the total weight of a layer to be added.

<Regarding Image Forming Method and Apparatus>

Then, the image forming method and image forming apparatus of the present invention will be described in detail based on the drawings. The image forming method and image forming apparatus of the present invention are an image forming method including processes of transfer of a toner image onto an image holding body (transfer paper), fixation and cleaning of a photoreceptor surface, for example, after undergoing at least stages of electrostatic charging of a photoreceptor, image light exposure, and development, using a laminated-type photoreceptor having a crosslinked-type charge transport layer that has very high abrasion resistance and scratch resistance and that hardly generates crack and film peeling at its surface, as well as an image forming apparatus. Optionally, the image forming method of directly transferring an electrostatic latent image onto a material to be transferred, followed by development does not necessarily have the aforementioned processes performed on the photoreceptor.

FIG. 2 is a schematic view showing one example of the image forming apparatus. As a means for averagely electrostatically charging the photoreceptor, a charger (3) is used. As the electrostatic charging means, a corotron device, a scorotron device, a solid discharging element, a needle electrode device, a roller electrostatic charging device, an electrically conductive brush device etc. are used, and known systems can be used. Particularly, the constitution of the present invention is particularly effective when an electrostatic charging means in which close discharge from an electrostatic charging means which becomes a cause for degradation of a photoreceptor composition is generated, such as a contact electrostatic charging system or a non-contact close arrangement electrostatic charging system is used. The contact electrostatic charging referred herein is an electrostatic charging system in which an electrostatic charging roller, an electrostatic charging brush, an electrostatic charging blade or the like is directly contacted with a photoreceptor. On the other hand, the close electrostatic charging system is, for example, a system in which an electrostatic charging roller is closely arranged in the non-contact state, so that a gap of 200 μm or less is possessed between a photoreceptor surface and an electrostatic charging means. When the gap is too great, electrostatic charging easily becomes unstable and, on the other hand, when the gap is too small, there is a possibility that an electrostatic charging member surface is stained in a case where a remaining toner is present on the photoreceptor.

Therefore, the gap is suitably in the range of 10 to 200 μm, preferably 10 to 100 μm.

Then, in order to form an electrostatic latent image on the uniformly electrostatically charged photoreceptor (1), an image light exposure part (5) is used. For this light source, general light emitting products such as a fluorescent lamp, a tungsten lamp, a halogen lamp, a mercury lamp, a sodium lamp, a light emitting diode (LED), a semiconductor laser (LD), and an electroluminescence (EL) can be used. In order to irradiate only light having a desired wavelength region, various filters such as a sharp cutting filter, a band pass filter, a near infrared cutting filter, a dichroic filter, an interference filter and a color temperature converting filter can also be used.

Then, in order to visualize the electrostatic latent image formed on the photoreceptor (1), a developing unit (6) is used. As a developing system, there are a one component developing method and a two component developing method using a dry toner, and a wet developing method using a wet toner. When the photoreceptor is positively (negatively) charged, and image light exposure is performed, a positive (negative) electrostatic latent image is formed on the photoreceptor surface. When it is developed with a toner (detecting fine particle) having negative (positive) polarity, a positive image is obtained and, when developed with a toner having positive (negative) polarity, a negative image is obtained.

Then, in order to transfer a toner image visualized on the photoreceptor onto a material to be transferred (9), a transfer charger (10) is used. In addition, in order to conduct transfer better, a pre-transfer charger (7) may be used. As these transfer means, an electrostatic transfer system, a pressure-sensitive adhesive transfer method, a mechanical transfer system such as a pressure transfer method, and a magnetic transfer system using a transfer charger, or a bias roller can be utilized. As the electrostatic transfer system, the aforementioned electrostatic charging means can be utilized.

Then, as a means for separating the material to be transferred (9) from the photoreceptor (1), a separation charger (11) and a separation nail (12) are used. As other separation means, electrostatic adsorption inducing separation, side end belt separation, tip grip conveyance, a curvature separation etc. are used. As the separation charger (11), the same system as that for the aforementioned electrostatic charging means can be utilized. Then, in order to clean a toner remaining on the photoreceptor after transfer, a fur brush (14) and a cleaning blade (15) are used.

Alternatively, in order to perform cleaning more effectively, a pre-cleaning charger (13) may be used. As other cleaning means, there are a web system, a magnetic brush system etc., and they may be used alone, or a plurality of systems may be used together. Then, if necessary, a neutralization means is used for the purpose of removing a latent image on the photoreceptor. As the neutralization means, a neutralization lamp (2), and a neutralization charger are used, and the exposing light source, and the electrostatic charging means can be utilized, respectively. In addition, as processes such as reading of manuscript which is not close to the photoreceptor, paper supply, fixation, paper discharge etc., known ones can be used.

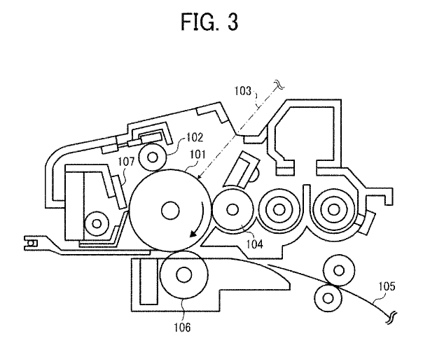

The present invention is the image forming method and image forming apparatus using the electrophotographic photoreceptor related to the present invention in the image forming means. This image forming means may be incorporated into a copying apparatus, a facsimile or a printer by fixation, or may be incorporated into those apparatuses in a form of a process cartridge, so that it is detachable. One example of the process cartridges is shown in FIG. 3.

The process cartridge for an image forming apparatus is an apparatus (part) which has a built-in photoreceptor (101) and, additionally, is provided with at least one of an electrostatic charging means (102), a developing means (104), a transfer means (106), a cleaning means (107), and a neutralization means (not shown), and is detachable from the image forming apparatus body. An image forming process by the apparatus exemplified in FIG. 3 will be shown; while the photoreceptor (101) is rotated in an arrow direction, electrostatic charging with the electrostatic charging means (102) and light exposure with a light exposing means (103) form an electrostatic latent image corresponding to a light exposed image on a surface thereof, this electrostatic latent image is toner-developed with the developing means (104), the toner development is transferred onto a transfer body (105) with the transfer means (106), and is printed out. Then, a surface of the photoreceptor after image transfer is cleaned with the cleaning means (107) and, further, is neutralized with a neutralization means (not shown), and the above procedures are repeated, again.

The present invention provides the process cartridge for an image forming apparatus, in which a laminated-type photoreceptor having, on a surface thereof, a crosslinked-type charge transport layer having very high abrasion resistance and scratch resistance, and in which crack and film pealing are generated with difficulty, and at least one of an electrostatic charging means, a developing means, a transfer means, a cleaning means, and a neutralization means is incorporated.

As apparent from the above explanation, the electrophotographic photoreceptor of the present invention not only can be utilized in an electrophotographic copying machine, but also can be widely used in the electrophotographic application field such as a laser beam printer, a CRT printer, a LED printer, a liquid crystal printer and a laser plate making.

Details of the measuring method of the present invention will be described.

<Measurement of Long Wavelength Side Absorption End of 2,5-diaryl-1,3,5-oxadiazole Derivative>

A DMF solution having a sample concentration of 5×10⁻⁵ mol/l is prepared, and an absorption spectrum is measured with a spectroscopic absorption apparatus using a quartz cell having an optical path length of 10 mm. A maximum absorbance of the resulting absorption peak on a longest wavelength side is obtained, and a spectrum place on a long wavelength side at which a magnitude thereof becomes 1/10 is defined as long wavelength side absorption end, and its wavelength is read.

<Measurement of Elastic Displacement Rate with Surface Microhardness Tester>

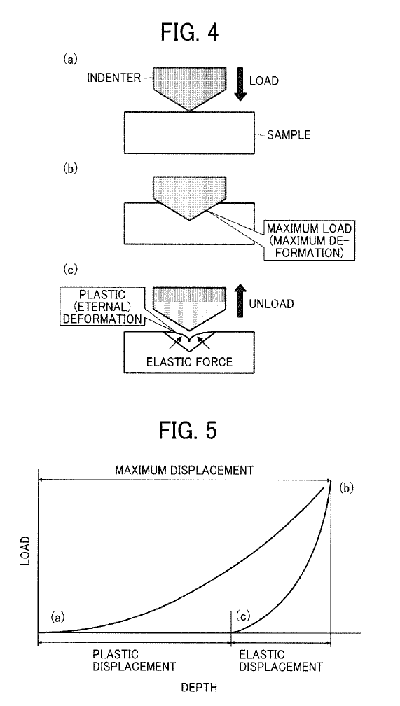

An elastic displacement rate τe in the present invention is measured by a loading-unloading test with a surface microhardness tester using a diamond indenter. As shown in FIG. 4, from a point (a) at which the indenter is contacted with a sample, the indenter is compressed in the sample at a constant loading rate (loading process), the indenter is rested for a constant time at a maximum displacement (b) at which a load reaches a set load and, further, the indenter is pulled up at a constant unloading rate (unloading process), and a point at which a load finally begins not to be applied to the intender is defined as plastic displacement (c). Thereupon, the resulting compression depth and a load curve are recorded as in FIG. 5, and an elastic displacement rate τe is calculated by the following equation, from a maximum displacement (b) and a plastic displacement (c).

Elastic displacement rate τe(%)=[(maximum displacement)−(plastic displacement)]/(maximum displacement)×100 [Mathematic]

The elastic displacement rate measurement is performed under constant temperature and humidity, and the elastic displacement rate in the present invention shows a measured value of the test which was conducted under the environmental condition of a temperature of 22° C. and a relative humidity of 55%.

In the present invention, a dynamic surface microhardness tester DUH-201 (manufactured by Shimadzu Corporation), and a trigonal pyramid indenter (115°) are used, but any value measured with any apparatus having the equal performance may be used. An elastic displacement rate τe was measured regarding arbitrary 10 places on a sample, and a standard deviation of an elastic displacement rate τe was calculated from this ten values. In measurement, the photoreceptor having a crosslinked surface layer of the present invention was manufactured on an aluminum cylinder, and this was appropriately cut, and used. Since an elastic displacement rate τe undergoes influence of spring property of a substrate and, as the substrate, a rigid metal plate, and a slide glass are suitable. Further, since elements of a hardness and an elasticity of a lower layer (e.g. charge transport layer, charge generation layer etc.) of the crosslinked surface layer also influence, a prescribed load was adjusted so that a maximum displacement became 1/10 a film thickness of the crosslinked surface layer, in order to decrease these influences. When only the crosslinked surface layer alone is manufactured on the substrate, since mixing in of lower layer components, and adherability with the lower layer are changed, and the surface crosslinked layer of the photoreceptor cannot be necessarily reproduced precisely, this is not preferable.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

A coating solution for an undercoat layer, a coating solution for a charge generation layer, and a coating solution for a first charge transport layer having the following compositions were sequentially immersion-coated on an aluminum cylinder of (φ60 mm having a polished surface, and dried to form a 3.5 μm undercoat layer, a 0.2 μm charge generation layer, and 20 μm first charge transport layer. A coating solution for a second charge transport layer having the following composition was spray-coated on this first charge transport layer, and spontaneously dried for 20 minutes, and light irradiation was performed under the conditions of a metal halide lamp: 160 W/cm, an irradiation distance: 120 mm, an irradiation intensity: 500 mW/cm², and an irradiation time: 180 seconds, to cure a coated film. Further, drying at 130° C. for 30 minutes was added to provide a 4.0 μm second charge transport layer, thereby, the electrophotographic photoreceptor of the present invention was manufactured.

[Coating solution for undercoat layer]

| | |
|---|---|
| Alkyd resin | 6 parts |
| (Beckosol 1307-60-EL, manufactured by DIC Corporation) | |
| Melamine resin | 4 parts |
| (Super Beckamine G-821-60, manufactured by DIC Corporation) | |
| Titanium oxide | 50 parts |
| Methyl ethyl ketone | 50 parts |

[Coating solution for charge generation layer]

| | | |
|---|---|---|
| Titanyl phthalocyanine | 1.5 | parts |
| Polyvinyl butyral (XYHL, manufactured by UCC) | 0.5 | part |
| Cyclohexanone | 200 | parts |
| Methyl ethyl ketone | 80 | parts |

[Coating solution for first charge transport layer]

| | | |
|---|---|---|
| Bisphenol Z polycarbonate (Panright TS-2050, manufactured by Teijin Chemicals LTD.) | 10 | parts |
| Low-molecular charge transport substance of the following formula (D-1) | 10 | parts |
| 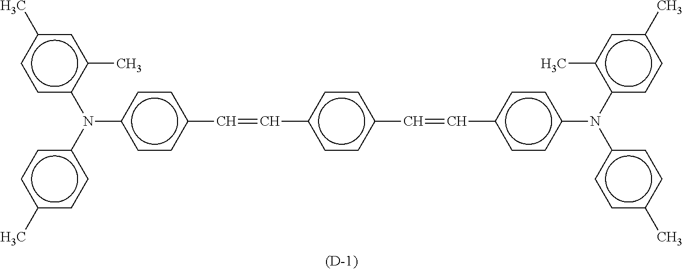 | | |
| Tetrahydrofuran | 100 | parts |
| Tetrahydrofuran solution of 1% silicone oil (KF50-100CS, manufactured by Shin-Etsu Chemical Co., Ltd.) | 0.2 | part |
| BHT | 0.2 | part |

[Coating solution for second charge transport layer]

| | | |
|---|---|---|
| The following non-charge transport polyfunctional radical | 10 | parts |
| polymerizable monomer | | |
| Trimethylolpropane triacrylate (KAYARAD TMPTA, manufactured by | | |
| Nippon Kayaku Co. , Ltd. ) molecular weight : 296, functional group | | |
| number: trifunctional, molecular weight/functional group number = 99 | | |
| The following radical polymerizable charge transport substance (D-2) | 10 | parts |
| 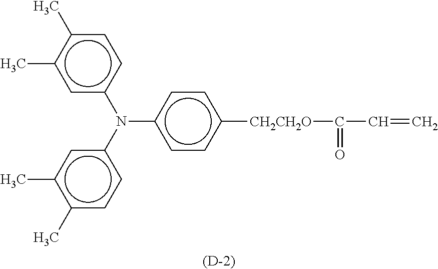 | | |
| Photopolymerization initiator | 1 | part |
| 1-Hydroxy-cyclohexyl-phenyl-ketone (Irgacure 184, manufactured by | | |
| Ciba Specialty Chemicals) | | |
| 2,5-Diaryl-1,3,4-oxadiazole derivative | 1 | part |
| The embodiment No.1 compound (a long wavelength side absorption | | |
| end of this compound was 369 nm) | | |
| Tetrahydrofuran | 100 | parts |

### Example 2

According to the same manner as that of Example 1 except that the 2,5-diaryl1,3,4-oxadiazole derivative was replaced with the embodiment 2 compound, an electrophotographic photoreceptor was manufactured.

Thereupon, a long wavelength side absorption end of the embodiment 2 compound was 336 nm.

### Example 3

According to the same manner as that of Example 1 except that the 2,5-diaryl1,3,4-oxadiazole derivative was replaced with the embodiment 3 compound, an electrophotographic photoreceptor was manufactured.

Thereupon, a long wavelength side absorption end of the embodiment 3 compound was 357 nm.

### Example 4

According to the same manner as that of Example 1 except that the 2,5-diaryl1,3,4-oxadiazole derivative was replaced with the embodiment 4 compound, an electrophotographic photoreceptor was manufactured.

Thereupon, a long wavelength side absorption end of the embodiment 4 compound was 330 nm.

### Example 5

According to the same manner as that of Example 1 except that the 2,5-diaryl1,3,4-oxadiazole derivative was replaced with the embodiment 5 compound, an electrophotographic photoreceptor was manufactured.

Thereupon, a long wavelength side absorption end of the embodiment 5 compound was 343 nm.

### Example 6

According to the same manner as that of Example 1 except that the 2,5-diaryl1,3,4-oxadiazole derivative was replaced with the embodiment 6 compound, an electrophotographic photoreceptor was manufactured.

Thereupon, a long wavelength side absorption end of the embodiment 6 compound was 364 nm.

### Example 7

According to the same manner as that of Example 1 except that the 2,5-diaryl1,3,4-oxadiazole derivative was replaced with the embodiment 7 compound, an electrophotographic photoreceptor was manufactured.

Thereupon, a long wavelength side absorption end of the embodiment 7 compound was 361 nm.

### Example 8

According to the same manner as that of Example 1 except that the 2,5-diaryl1,3,4-oxadiazole derivative was replaced with the embodiment 8 compound, an electrophotographic photoreceptor was manufactured.

Thereupon, a long wavelength side absorption end of the embodiment 8 compound was 347 nm.

### Example 9

According to the same manner as that of Example 1 except that the 2,5-diaryl1,3,4-oxadiazole derivative was replaced with the embodiment 9 compound, an electrophotographic photoreceptor was manufactured.

Thereupon, a long wavelength side absorption end of the embodiment 9 compound was 347 nm.

### Example 10

According to the same manner as that of Example 1 except that the 2,5-diaryl1,3,4-oxadiazole derivative was replaced with the embodiment 10 compound, an electrophotographic photoreceptor was manufactured.

Thereupon, a long wavelength side absorption end of the embodiment 10 compound was 334 nm.

### Example 11

According to the same manner as that of Example 1 except that the 2,5-diaryl-1,3,4-oxadiazole compound was replaced with a compound of the following structure III, an electrophotographic photoreceptor was manufactured.

Thereupon, a long wavelength side absorption end of the following (formula III) compound was 428 nm.

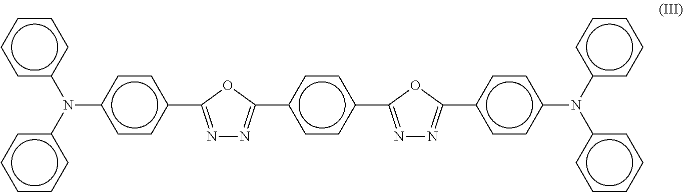

### Example 12

According to the same manner as that of Example 1 except that the 2,5-diaryl-1,3,4-oxadiazole compound was replaced with a compound of the following structure IV, an electrophotographic photoreceptor was manufactured.

Thereupon, a long wavelength side absorption end of the following (formula IV) compound was 402 nm.

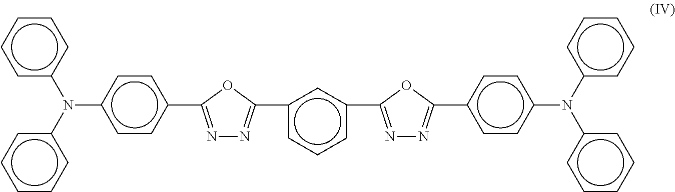

### Comparative Example 1

According to the same manner as that of Example 1 except that 2,5-diaryl-1,3,4-oxadiazole derivative was not used, an electrophotographic photoreceptor was manufactured.

### Comparative Example 2

According to the same manner as that of Example 1 except that 2,5-diaryl-1,3,4-oxadiazole derivative was replaced with a compound of the following structure V, an electrophotographic photoreceptor was manufactured.

Thereupon, a long wavelength side absorption end of the following (formula V) compound was 388 nm.

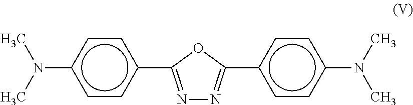

### Comparative Example 3

According to the same manner as that of Example 1 except that 2,5-diaryl-1,3,4-oxadiazole derivative was replaced with a compound of the following structure, an electrophotographic photoreceptor was manufactured. Thereupon, a long wavelength adsorption end of this compound was 345 nm.

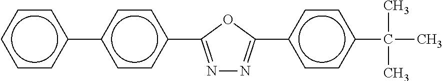

The electrophotographic photoreceptors obtained in the above Examples 1 to 12 and Comparative Examples 1 to 3 were electrostatically charged at −800V with a Scorotron charging device, and wholly written with a 780 nm semiconductor laser at a light level of 0.30 uj/cm² for an irradiation time of 89 ms, a potential in a longitudinal direction and a circumferential direction of the photoreceptor was measured, and a maxim potential and a minimum potential among them were measured. In addition, an elastic displacement rate τe was measured with a surface microhardness tester as an average of arbitrary 10 places in a longitudinal direction of the photoreceptor. These results are shown in Table 1.

TABLE 1

| | Maximum | | | Elastic |
|---|---|---|---|---|
| | potential | Minimum | Potential | displacement |
| | (−V) | potential (−V) | difference (V) | rate (%) |
| Example 1 | 164 | 132 | 32 | 42.1 |
| Example 2 | 151 | 120 | 31 | 41.8 |
| Example 3 | 138 | 108 | 30 | 41.9 |
| Example 4 | 140 | 112 | 26 | 42.0 |
| Example 5 | 150 | 118 | 32 | 42.1 |
| Example 6 | 159 | 130 | 29 | 41.8 |
| Example 7 | 148 | 114 | 34 | 42.1 |
| Example 8 | 152 | 118 | 34 | 42.0 |
| Example 9 | 167 | 139 | 28 | 42.2 |
| Example 10 | 147 | 115 | 32 | 42.0 |
| Example 11 | 165 | 132 | 33 | 37.6 |
| Example 12 | 166 | 134 | 32 | 38.8 |
| Comparative | 235 | 184 | 51 | 42.1 |
| Example 1 | | | | |
| Comparative | 326 | 270 | 56 | 39.3 |
| Example 2 | | | | |
| Comparative | 233 | 185 | 48 | 41.0 |
| Example 3 | | | | |

As described above, it is seen that a difference between a maximum potential and a minimal potential in a photoreceptor plane becomes small while a hardness is hardly dropped, by adding the 2,5-diaryl-1,3,4-oxadiazole derivative represented by the general formula (1) or the general formula (2). On the other hand, it is seen that, when the 2,5-diaryl-1,3,4-oxadiazole derivative having a dimethylamino group as a substituent is added, as shown in Comparative Example 2, a residual potential becomes great, a potential after light irradiation becomes higher and, at the same time, an in-plane potential difference can be reduced.

When the elastic displacement rate τe showing mechanical durability of the photoreceptor is seen, 35% or more as measure of high durability is satisfied in all cases, there is little change as compared with the case of addition of no 2,5-diaryl-1,3,4-oxadiazole derivative, and it is seen that there is little side effect on durability.

However, in the case of Example 11 and Example 12 and Comparative Example 2 where a long wavelength side absorption end of the 2,5-diaryl-1,3,4-oxadiazole derivative exceeds 380 nm, an elastic displacement rate is slightly smaller as compared with Examples 1 to 10 in which a long wavelength side absorption end is 380 nm or less, it is presumed that a crosslinking reaction is slightly inhibited by absorption of a part of light by the 2,5-diaryl-1,3,4-oxadiazole derivative at a crosslinking reaction with ultraviolet ray irradiation. Therefore, it is seen that use of the 2,5-diaryl-1,3,4-oxadiazole derivative having a long wavelength side absorption end of 380 nm or less is more preferable.

From these things, it is apparent that mechanical durability is not different from the previous high durability electrophotographic photoreceptor, and it has become possible to output an image of higher image quality, by adding a specified 2,5-diaryl-1,3,4-oxadiazole derivative to a second charge transport layer, particularly, by using the derivative having its long wavelength side absorption end of 380 nm or less.

### Example 13

According to the same manner as that of Example 1 except that the aluminum cylinder of φ60 nm having a polished surface was replaced with an aluminum cylinder of φ100 nm having a cutting-processed surface, an electrophotographic photoreceptor was manufactured.

This electrophotographic photoreceptor was set on the on demand printing RICOH Pro C9000 manufactured by Ricoh Company, Ltd., and image outputting of continuous 500 at a test pattern of each middle tone zone pattern of yellow, magenta, cyan and black was performed at a printing rate of 90 per minutes, using A4 papers of Ricoh full color PPC paper-type 6000 at resolution of 1200×1200 dpi. Images of 1 to 5 and 495 to 500 were aligned, and in-plane variation of an image concentration was rank-assessed visually, respectively.

Rank 5: Variation is not seen.
Rank 4: Little variation is seen.
Rank 3: Slight variation is seen in a part of images.
Rank 2: Slight variation is seen in all images.
Rank 1: Variation is clearly seen in all images.
The results are shown in Table 2.

### Comparative Examples 4 and 5

According to the same manner except that an electrophotographic photoreceptor manufactured according to the same manner as that of Example 13 except that the 2,5-diaryl-1,3,4-oxadiazole derivative was not used in the second charge transport layer, and the electrophotographic photoreceptor manufactured in Comparative Example 3 were used, in-plane variation of an image concentration was assessed. The results are also shown in Table 2.

TABLE 2

| | | 495 to 500 in-plane |
|---|---|---|
| | 1 to 5 in-plane concentration | concentration variation |
| | variation assessment rank | assessment rank |
| Example 13 | 4 | 4 |
| Comparative | 3 | 2 |
| Example 4 | | |
| Comparative | 3 | 2 |
| Example 5 | | |

As described above, the electrophotographic photoreceptor of the present invention has little variation in a plane of an image concentration as compared with the previous products, and has made possible to output an image of high image quality. In addition, this property is maintained also after large scale high speed output, and an image outputting image, and an image outputting apparatus which can respond to high image quality, high speed, and stability at large scale printing required in the commercial printing field can be provided.

### Example 14

The electrophotographic photoreceptor manufactured in Example 1 was mounted in a process cartridge of a digital full color complex machine MP C7500SP manufactured by Ricoh Company, Ltd., this was attached to a body, and continuous 100 image outputting at a test pattern of each middle tone zone pattern of yellow, magenta, cyan and black was performed at a printing rate of 60 per minutes, using A4 papers of Ricoh My Recycle Paper GA at resolution of 600×600 dpi. Images of 1 to 6 and 95 to 100 were aligned, and in-plane variation of an image concentration was rank-assessed visually as in Example 14. The results are shown in Table 3.

### Comparative Examples 6 and 7

According to the same manner as that of Example 14 except the electrophotographic photoreceptors manufactured in Comparative Example 1 and Comparative Example 3 were used, in plane variation of an image concentration was assessed. Results are shown in Table 3.

TABLE 3

| | | 95 to 100 in-plane |
|---|---|---|
| | 1 to 5 in-plane concentration | concentration variation |
| | variation assessment rank | assessment rank |
| Example 14 | 5 | 5 |
| Comparative | 4 | 3 |
| Example 6 | | |
| Comparative | 4 | 3 |
| Example 7 | | |

As described above, even when a process cartridge for an image forming apparatus using the electrophotographic photoreceptor of the present invention is used, in-plane variation of an image concentration is small as compared with the previous products, and image outputting of high image quality has become possible. In addition, this property is maintained also after large scale high speed image outputting, and a process cartridge for an image forming apparatus which can respond to high image quality, high speed, and stability at large scale printing required in the commercial printing field can be provided.

Additional modifications and variations of the present invention are possible in light of the above teachings. It is therefore to be understood that within the scope of the appended claims the invention may be practiced other than as specifically described herein.

This document claims priority and contains subject matter related to Japanese Patent Application No. 2009-212696, filed on Sep. 15, 2009, the entire contents of which are herein incorporated by reference.

What is claimed is:

1. An electrophotographic photoreceptor, comprising:
an electroconductive substrate;
a charge generation layer overlying the substrate;
a first charge transport layer mostly formed of a molecular dispersion film in which a binder resin comprises a low-molecular-weight charge transport material, overlying the charge generation layer; and
a second charge transport layer formed of a crosslinked film obtained by irradiating a composition obtained by mixing a radical polymerizable charge transport compound, a tri- or more functional radical polymerizable monomer, and a photopolymerization initiator with ultraviolet radiation to conduct a radical curing reaction, overlying the first charge transport layer,
wherein the crosslinked film comprises at least one of 2,5-diaryl-1,3,4-oxadiazole derivatives having the following formulae (1) and (2): 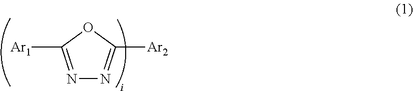
wherein i represents an integer of 1 to 4, Ar₁, when i=1, represents a naphthyl group or a biphenylyl group and, when i is 2 to 4, represents an aryl group, the plurality of aryl groups may be the same or different, and Ar₂, when i=1, represents a naphthyl group or a biphenylyl group, when i is 2 to 4, represents a divalent to tetravalent group of a benzene ring corresponding to I; and 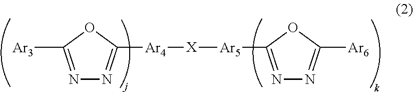
wherein j and k represent an integer of 1 to 2, Ar₃ and Ar₆ represent an aryl group, Ar₄ represents a divalent to tetravalent group of a benzene ring, Ar₅ represents a divalent group or trivalent group of a benzene ring corresponding to k, and X represents a divalent hydrocarbon group, and may be taken together with adjacent Ar₄ to form a ring structure via a substituent.

2. The electrophotographic photoreceptor of claim 1, wherein each of the Ar₁ to Ar₆ does not have a substituent.

3. The electrophotographic photoreceptor of claim 1, wherein the aryl group represented by Ar₁, Ar₃ or Ar₆ is a phenyl group, a naphthyl group, or a biphenylyl group.

4. The electrophotographic photoreceptor of claim 1, wherein the 2,5-diaryl-1,3,4-oxadiazole derivative has a long wavelength side absorption end of 380 nm or less.

5. An image forming method of repeating steps, comprising:
charging the photoreceptor according to claim 1;
irradiating the photoreceptor to form an electrostatic latent image thereon;
developing the electrostatic latent image with a toner to form a toner image; and
transferring the toner image onto a transfer paper.

6. An image forming apparatus, comprising:
the photoreceptor according to claim 1;
a charger configured to charge the photoreceptor;
an irradiator configured to irradiate the photoreceptor to form an electrostatic latent image thereon;
an image developer configured to develop the electrostatic latent image with toner to form a toner image; and
a transferer configured to transfer the toner image onto a transfer paper.

7. A process cartridge for an image forming apparatus, detachable therefrom, comprising:
the photoreceptor according to claim 1; and
at least one of a charger, an image developer, a transferer, a cleaner and a discharger.
